(19) United States
(12) Patent Application Publication
(10) Pub. No.: US 2026/0166697 A1
(43) Pub. Date: Jun. 18, 2026

(54) MAGAZINE EXTENSION FOR A POWERED NAILER

(71) Applicant: Illinois Tool Works Inc., Glenview, IL (US)

(72) Inventor: Ole SKALSHØI, Middelfart (DK)

(21) Appl. No.: 19/414,760

(22) Filed: Dec. 10, 2025

(30) Foreign Application Priority Data
Dec. 13, 2024 (GB) 2418342.8

(51) Int. Cl. B25C 1/00

(52) U.S. Cl. CPC B25C 1/001

(57) ABSTRACT

A magazine extension for a powered nailer, wherein the magazine extension comprises a body delimiting a channel for receipt of nails, and a retainer member. The retainer member extends from the body to releasably hold the magazine extension in fixed relation to a magazine of the powered nailer so to provide a supply of nails received in the channel to the magazine. There is also disclosed a magazine assembly comprising the magazine extension, and a powered nailer comprising the magazine extension.

### PRIORITY CLAIM

This application claims priority to and the benefit of Great Britan Application No. 2418342.8, filed Dec. 13, 2024, the entire contents of which are incorporated herein by reference.

### TECHNICAL FIELD

The present disclosure relates generally to powered nailers. More particularly, the present disclosure relates to a magazine extension, a magazine assembly comprising the magazine extension, and a powered nailer comprising the magazine extension.

### BACKGROUND

Powered nailers are tools used to drive nails into various materials. Widely used in construction, carpentry, and home improvement, these tools significantly speed up tasks like framing, roofing, and flooring, compared to traditional hammering, making them essential in settings where speed and precision is important. Powered nailers come in various types, including pneumatic (air-powered), electric (corded and battery-operated), and combustion-powered models, wherein the power source provides the necessary force to drive the nails into the target material. Nailers include a magazine to store a supply of nails, typically in strips or coils, and to continuously feed a supply of nails to a drive chamber from where the nails are driven from the nailer. Magazines have a fixed maximum nail capacity. Magazines with a low capacity can require frequent reloading, which can interrupt workflow and slow down productivity. Higher-capacity magazines reduce the need for frequent reloading, allowing for more continuous work. However, higher-capacity magazines may lead to other issues, resulting from increased weight and reduced manoeuvrability.

It is an advantage of embodiments of the present disclosure to provide an improved magazine assembly, and/or at least mitigate one or more problems associated with known arrangements.

### SUMMARY

According to an aspect of the present disclosure, there is provided a magazine extension for a powered nailer, the extension comprising: a body delimiting a channel for receipt of nails; and a retainer member extending from the body to releasably hold the extension in fixed relation to a magazine of the powered nailer so to provide a supply of nails received in the channel (when in use) to the magazine. The magazine extension provides flexibility when using the powered nailer, thereby offering several practical benefits, including improved usability, efficiency, and/or versatility. In particular, the magazine extension allows the capacity of the magazine to be selectively increased/decreased allowing adaptability to the size of the task. Additionally, or alternatively, the ergonomics and weight of the nailer can be readily altered, and/or the magazine extension may allow for faster reloading.

In certain embodiments, the body may comprise a pair of opposing side walls between which the channel is delimited, the retainer member extending from a first wall of the pair of opposing side walls. The extension may comprise a further retainer member extending from a second wall of the pair of opposing side walls also to releasably hold the magazine extension in said fixed relation.

In certain embodiments, the body may comprise a further side wall extending between and joining the opposing side walls to one another at a first side of the body. Additionally, or alternatively, the channel is open along a second side of the body to allow relative movement of the opposing side walls. The further side wall may be elastically deformable (flexible) to allow the relative movement of the opposing side walls and/or one or both of the opposing side walls may be elastically deformable to allow the relative movement of the opposing side walls.

In certain embodiments, the opposing side walls and the further side wall may together provide the body a substantially U-shaped profile and/or the body may be formed as a single piece.

In certain embodiments, the body and/or the retainer member may provide a snap-fit connector. Additionally, or alternatively, the retainer member may extend from the body to releasably hold the magazine extension in fixed relation to a magazine of the powered nailer absent fasteners, such as screws, so to provide a supply of nails received in the channel to the magazine.

In certain embodiments, the retainer member and/or the further retainer member may comprise a respective cantilever beam and a barb at a free end of the cantilever beam.

In certain embodiments, one of the retainer member and the further retainer member may extend further than the other from the body. Additionally, or alternatively, the channel may comprise first and second openings at respective ends of the body, the first opening for passage of nails out of the channel and the second opening for passage of nails into the channel. The extension may comprise a closure member to selectively close the second opening such that nails cannot pass out of the channel therethrough.

According to another aspect of the present disclosure, there is provided a magazine assembly for a powered nailer, the assembly comprising: a magazine having a profiled surface; and a magazine extension as describe above, the retainer member engaged with the profiled surface and thereby releasably holding the magazine extension in said fixed relation.

In certain embodiments, nails received in the channel are freely movable (by a user) from the channel to the magazine. The magazine may comprise a follower to bias nails received in the magazine so to provide a supply of nails received in the magazine to the powered nailer. Additionally, or alternatively, the magazine and the magazine extension may together make a form fit.

According to another aspect of the present disclosure, there is provided a powered nailer comprising a magazine assembly as described above, the powered nailer being one of combustion powered, electric powered, and pneumatic powered.

### BRIEF DESCRIPTION OF THE DRAWINGS

Embodiments of the present disclosure will now be described, by way of example only, with reference to the accompanying figures.

FIG. 1 is a perspective view of a powered nailer according to an embodiment of the present disclosure.

FIG. 2 is a perspective view of a magazine extension according to an embodiment of the present disclosure.

FIG. 3 is a perspective view of the magazine extension of FIG. 2, showing sides of the magazine extension not visible in FIG. 2.

FIG. 4 is a cross-sectional perspective view of the magazine extension of FIG. 2, showing a channel of the magazine extension.

### DETAILED DESCRIPTION

While the features, devices, and apparatus described herein may be embodied in various forms, the drawings show and the specification describe certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as coupled, mounted, connected, and the like, are not intended to be limited to direct mounting methods but should be interpreted broadly to include indirect and operably coupled, mounted, connected and like mounting methods. This specification is intended to be taken as a whole and interpreted in accordance with the principles of the present disclosure and as understood by one of ordinary skill in the art.

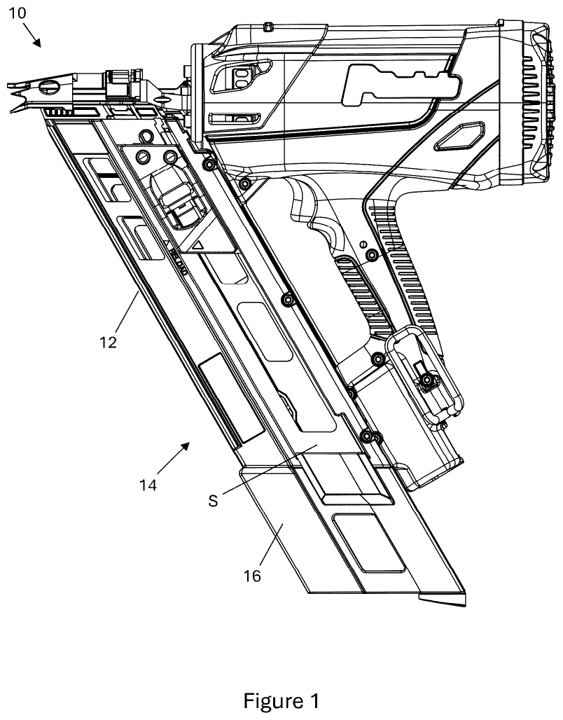

FIG. 1 shows a powered nailer 10 according to an embodiment of the present disclosure. The nailer 10 is configured for sequentially driving a plurality of nails (not shown) into a workpiece. The configuration and operation of the nailer 10 may be according to known nailers and staplers, such as those described in earlier patent documents, including U.S. Pat. Nos. 4,522,162, 4,483,473, 4,483,474, 4,403,722, 5,197,646, 5,263,439, 6,145,724, and 7,341,171. The nailer 10 may be powered by any suitable source. As such, the nailer 10 may be combustion powered, electric powered, or pneumatic powered.

As is conventional, the nailer 10 comprises a magazine 12. The magazine 12 is constructed and arranged for storing and sequentially feeding a plurality of nails into a nail entry of the nailer 10. Nails are loaded into the magazine, for example through an opening in the bottom thereof. The powered nailer 10 further comprises a magazine assembly 14, the magazine assembly comprising the magazine 12 and a magazine extension 16.

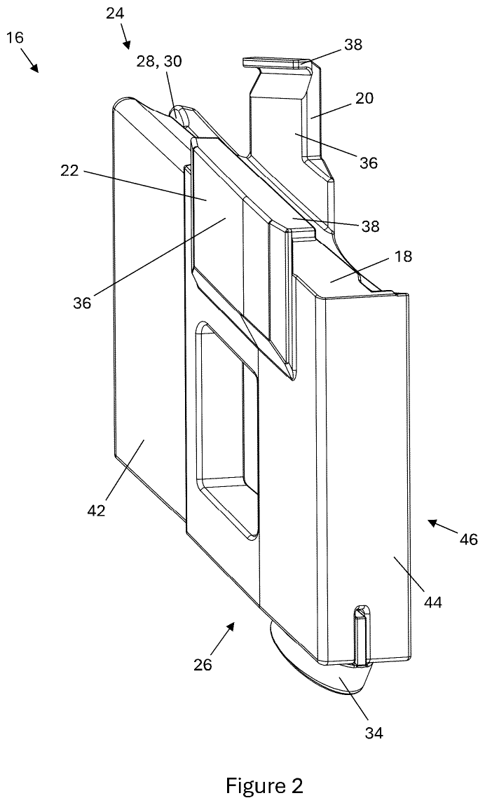

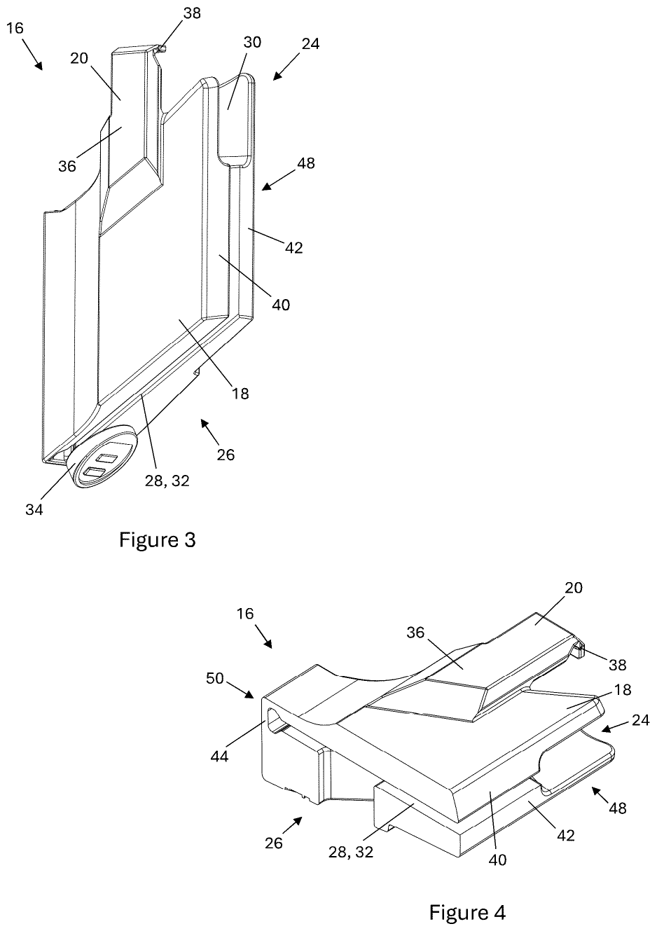

FIGS. 2, 3, and 4 show the magazine extension 16 detached from the magazine 12. The extension 16 comprises a body 18 and first and second retainer members 20, 22. The body 18 extends longitudinally from a first end 24 to a second end 26, and delimits a channel 28 extending the whole length of the body 18 for receipt of nails (i.e., the channel 28 extends from the first end 24 to the second end 26). The first and second retainer members 20, 22 extend from the body 18 and beyond the first end 24 in order to engage with the magazine 12 and/or the nailer 10. This engagement is to releasably hold the extension 16 in fixed relation to the magazine 12, so to provide a supply of nails received in the channel 28 to the magazine 12. Each of the first and second retainer members 20, 22 engage with a profiled surface S of the magazine 12 to releasably hold the extension 16 in fixed relation thereto, as will be described in more detail below. Used herein, including in the appended claims, the term “profiled surface” is to be understood to mean a surface shaped to include features such as ridges, grooves, edges, or other structural elements (i.e., the profiled surface S has a contour or pattern), which may be for aesthetic, functional, and/or mechanical purposes.

The channel 28 comprises a first opening 30 and a second opening 32 at the first and second ends 24, 26 of the body 18, respectively. The first opening 30 is for passage of nails out of the channel 28 and, when the extension 16 is connected to the magazine 12, into the magazine 12 to provide the supply of nails to the magazine 12. When fixed to the magazine 12, the channel 28 will therefore be aligned with a similar feature of the magazine 12 for the receipt of nails, with nails movable from the extension 16 into the magazine 12. The second opening 32 is for passage of nails into the channel 28, to allow a user to load nails into the extension 16. The extension 16 further comprises a closure member 34 to selectively close the second opening 32 such that nails cannot pass out of the channel 28 therethrough. The closure member 34 may take any suitable form, including a cap or cover. In the illustrated embodiment, the closure member 34 is pivotably attached to the body 18, and is moveable/rotatable to partially close over the second opening 32. The second opening 32 need not be fully closed over by the closure member 34, so long as the closure member 34 sufficiently occludes the second opening 32 to prevent nails from falling out of the channel 28.

As shown in the illustrated embodiment, each of the first and second retainer members 20, 22 may comprise a respective cantilever beam 36 and a barb 38 at a free end of the beam 36. However, any suitable configuration of the retainer members 20, 22 may be provided. A suitable configuration may be any configuration where the magazine 12 and the extension 16 make a form-fit, thereby each fitting snugly against or around the other, with the first and second retainer members 20, 22 engaged with the magazine 12. To make the engagement, the body 18 and/or at least one of the retainer members 20, 22 may be elastically deformable, to allow a portion (e.g., the barb 38) of the at least one of the retainer members 20, 22 to move over and behind a portion of the magazine 12 forming the profiled surface S, as the magazine 12 and the extension are brought together, and make the engagement. In this way, the body 18 and/or the at least one of the retainer members 20, 22 may form or provide a snap-fit connector. Used herein, including in the appended claims, the term “elastically deformable” is to be understood to mean the ability of an object (e.g., at least one of the beams 36) to temporarily change its shape under a force and return to its original shape once the force is removed. In the context of the present disclosure, the force applied is applied by a user's hand, either directly or indirectly (e.g., by holding the magazine 12 and the extension 16 and pushing them together resulting in the elastic deformation of the relevant feature).

The body 18 comprises a pair of opposing side walls 40, 42 (first and second side walls) between which the channel 28 is delimited. Each of the retainer members 20, 22 extend from a respective one of the side walls 40, 42. In this way, each of the retainer members 20, 22 engages with a respective side of the magazine 12. The body 18 further comprises a further side wall 44. The further side wall 44 extends between the opposing side walls 40, 42 and joins the opposing side walls 40, 42 to one another at a first side 46 of the body 18. At a second side 48 of the body 18, the opposing side walls 40, 42 are not joined to one another and therefore the body 18 is open to the channel 28 (i.e., the channel 28 is open along the second side 44 of the body 18). Accordingly, the opposing side walls 40, 42 and the further side wall 44 together provide the body a substantially U-shaped profile. In certain embodiments, the body 18 being open to the channel 28 is to allow relative movement of the opposing side walls 40, 42—in particular, regions or edges of opposing side walls 40, 42 extending along or adjacent the second side 48 of the body 18. In such embodiments, some part of the body 18 may be elastically deformable to allow the relative movement, including one or more of the opposing side walls 40, 42 and the further side wall 44. To provide the required elastic deformation, a thickness of the body 18 may be reduced relative to that of the remainder of the body 18. In this way, a region of the body 18 may provide a living hinge.

As in the illustrated embodiment, the further side wall 44 may provide (i.e., may be configured to exhibit) the required elastic deformation. Therefore, the formation of the further side wall 44 may allow a portion (e.g., the barb 38) of the at least one of the retainer members 20, 22 to move over and behind a portion of the magazine 12 forming the profiled surface S and make the engagement. Elastic deformation of other features (e.g., one of or both of the retainer members 20, 22) when fixing the extension 16 and to the magazine 12, may be incidental. Though, one or both of the retainer members 20, 22 (i.e., by virtue of the respective beam 36) could additionally be configured to elastically deform. FIG. 4 shows the cross-section of the body 18, in which a thickness of the further side wall 44 is reduced over a region 50 relative to the surrounding regions of the body 18. This reduction in thickness extends along the length of the body 18. The region 50 therefore provides a living hinge allowing the relative movement of the opposing side walls 40, 42.

One of the first and second retainer members 20, 22 may extend further from the body 18 than the other. Such further extension may be longitudinally and/or laterally from the body 18. The precise way in which each of the first and second retainer members 20, 22 extend from the body 18 may depend upon the profiled surface S of the magazine 12. By configuring the first and second retainer members 20, 22 to engage with features of the profiled surface S, the extension 16 may be configured to fix to existing magazine designs, without the need for modifications thereto. Also, the eccentricity of one of the first and second retainer members 20, 22 extending further from the body 18 than the other may facilitate fixing and unfixing the extension 16 to/from the magazine 12. As in the illustrated embodiment, the body 18 may be formed as a single piece. This makes the extension 16 simple, robust, and inexpensive to produce.

To engage the magazine 12 and the extension 16 with one another, a user approximately aligns the magazine 12 and extension 16 and pushed the two together to engage the opposing side walls 40, 42 and the profiled surface S with one another. By fixing the magazine and the extension to one another as described, the fixation may be achieved without the need of tools and/or fasteners (e.g., screws). so, no moving parts are required to make the engagement, reducing components and/or rusting, contributing to the simplicity of the extension 16.

The present disclosure is not restricted to the details of any foregoing embodiments. Throughout the description and claims of this specification, the words “comprise” and “contain” and variations of them mean “including but not limited to,” and they are not intended to (and do not) exclude other moieties, additives, components, integers, or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, or characteristics described in conjunction with a particular aspect, embodiment or example of the present disclosure are to be understood to be applicable to any other aspect, embodiment or example described herein unless incompatible therewith. In particular, the words “certain embodiments” are to be understood to mean any embodiment described, illustrated, or otherwise disclosed herein, unless expressly stated otherwise. All of the features disclosed in this specification (including any accompanying claims, abstract and drawings), and/or all of the steps of any method or process so disclosed, may be combined in any combination, except combinations where at least some of such features and/or steps are mutually exclusive. The present disclosure extends to any novel one, or any novel combination, of the features disclosed in this specification (including any accompanying claims, abstract and drawings), or to any novel one, or any novel combination, of the steps of any method or process so disclosed.

1. A magazine extension for a powered nailer, the magazine extension comprising:
a body defining a channel sized and shaped to receive nails; and
a retainer member extending from the body and engagable with a magazine of the powered nailer to releasably hold the magazine extension in a fixed position relative to the magazine and to provide a supply of nails received in the channel to the magazine.

2. The magazine extension of claim 1, wherein the body includes a first side wall and an opposing second side wall that define the channel, and wherein the retainer member extends from the first side wall.

3. The magazine extension of claim 2, which includes a further retainer member extending from the second side wall, the further retainer member also engagable with the magazine to releasably hold the magazine extension in the fixed position relative to the magazine.

4. The magazine extension of claim 2, wherein the body includes a further side wall extending between and joining the first and second side walls to one another at a first side of the body.

5. The magazine extension of claim 4, wherein the channel is open along a second side of the body to enable relative movement of the first and second side walls.

6. The magazine extension of claim 5, wherein the further side wall is elastically deformable to enable said movement.

7. The magazine extension of claim 5, wherein one or both of the first and second side walls are elastically deformable to enable said movement.

8. The magazine extension of claim 4, wherein the first and second side walls and the further side wall define a U-shaped profile.

9. The magazine extension of claim 1, wherein the body is formed as a single piece.

10. The magazine extension of claim 1, wherein one or both of the body and the retainer member provide a snap-fit connector.

11. The magazine extension of claim 3, wherein one of the retainer member and the further retainer member includes a cantilever beam and a barb at a free end of the cantilever beam.

12. The magazine extension of claim 3, wherein one of the retainer member and the further retainer member extends further than the other from the body.

13. The magazine extension of claim 1, wherein the channel includes a fastener inlet and a fastener outlet.

14. The magazine extension of claim 13, which includes a closure member movable to selectively close the fastener inlet.

15. A magazine assembly for a powered nailer, the magazine assembly comprising:
a magazine having a profiled surface; and
a magazine extension including:
a body defining a channel sized and shaped to receive nails, and
a retainer member extending from the body and engagable with the profiled surface of the magazine of the powered nailer to releasably hold the magazine extension in a fixed position relative to the magazine to provide a supply of nails received in the channel to the magazine.

16. The magazine assembly of claim 15, wherein the magazine extension is configured such that nails received in the channel are freely movable from the channel to the magazine.

17. The magazine assembly of claim 16, wherein the magazine includes a follower positioned to bias nails received in the magazine.

18. A powered nailer comprising:
a magazine assembly comprising:
a magazine having a profiled surface; and
a magazine extension including:
a body defining a channel sized and shaped to receive nails, and
a retainer member extending from the body and engagable with the profiled surface of the magazine of the powered nailer to releasably hold the magazine extension in a fixed position relative to the magazine to provide a supply of nails received in the channel to the magazine.
